(19) United States
(12) Patent Application Publication
(10) Pub. No.: US 2021/0106938 A1
(43) Pub. Date: Apr. 15, 2021

(54) Air Filter Assembly

(71) Applicant: Trophy Air LLC, Trophy Club, TX (US)

(72) Inventors: Robert Lee Zimmerman, III, Trophy Club, TX (US); Christine Zimmerman, Trophy Club, TX (US)

(21) Appl. No.: 16/599,843

(22) Filed: Oct. 11, 2019

(51) Int. Cl. B01D 46/52; B01D 46/00

(52) U.S. Cl. CPC B01D 46/521; B01D 46/0016; B01D 46/10; B01D 46/008; B01D 46/0005

(57) ABSTRACT

An air filter assembly includes a pleated air filter media having an upstream surface, a downstream surface, a first side end, and a second side end; a wire netting adjoined to the downstream surface of the air filter media; and a graspable end member adjoined to each of the first and second side ends of the air filter media. The assembly further includes a frame configured to releasably retain the air filter media, the frame having first and second ends walls and first and second side walls; a closure assembly for securing the air filter media within the frame, the closure assembly comprising a spring-loaded fastener pivotably coupled to at least one of the first and second side walls and configured to fasten to at least one of the first and second end walls; and an efficiency grid retained within the frame.

### TECHNICAL FIELD

The present disclosure relates to an air filter assembly, and more particularly, the present disclosure relates to an air filter assembly comprising an air filter frame for releasably retaining a replaceable air filter media.

### BACKGROUND

Disposable air filters are commonly used in heating, ventilation, and air conditioning (“HVAC”) systems to remove dust and particles from the air and improve indoor air quality. Filtration usually occurs when expended air is brought back into the HVAC equipment to be conditioned and distributed again. The air is forced through the air filter, which traps particulates and other contaminants that are in the air. Conventional air filters include an air filter media supported by a disposable cardboard frame. When the air filter media becomes dirty or clogged, the entire structure—both the air filter media and the cardboard frame—must be replaced.

### SUMMARY

The present disclosure relates to an air filter assembly, and more particularly, the present disclosure relates to an air filter assembly comprising a replaceable air filter media and an air filter frame for releasably retaining the air filter media.

In some implementations, the air filter assembly may comprise a pleated air filter media having an upstream surface, a downstream surface, a first side end, and a second side end; a wire netting adjoined to the downstream surface of the air filter media; a graspable end member adjoined to each of the first and second side ends of the air filter media; a frame configured to releasably retain the air filter media, the frame having first and second ends walls and first and second side walls; a closure assembly for securing the air filter media within the frame, the closure assembly comprising a spring-loaded fastener pivotably coupled to at least one of the first and second side walls and configured to fasten to at least one of the first and second end walls; and an efficiency grid retained within the frame.

In some implementations, the air filter media may comprise a replaceable air filter media; a frame configured to releasably retain the air filter media; an efficiency grid disposed within the frame for supporting the air filter media during operation of the air filter assembly; and a closure assembly for securing the air filter media within the frame.

In some implementations, the air filter assembly may comprise a replaceable air filter media; a frame configured to releasably retain the air filter media; a closure assembly for securing the air filter media within the frame, wherein the closure assembly comprises at least one spring-loaded fastener coupled to a first side of the frame and configured to fasten to a second side of the frame; and an efficiency grid configured to be retained within the frame.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1A illustrates a perspective view of an upstream side of an air filter frame for use with an air filter assembly, according to the present disclosure;

FIG. 1B illustrates a perspective view of a downstream side of the air filter frame of FIG. 1A, according to the present disclosure;

FIG. 1C illustrates a perspective view of the inside of a sidewall of the air filter frame of FIG. 1A, according to the present disclosure;

FIG. 2 illustrates a perspective view of an air filter media for use with an air filter assembly, according to the present disclosure;

FIG. 3A illustrates a perspective view of an implementation of an assembled air filter assembly in an open position, according to the present disclosure;

FIG. 3B illustrates a perspective view of the assembled air filter assembly of FIG. 3A in a closed position, according to the present disclosure;

FIG. 4A illustrates a perspective view of another implementation of an assembled air filter assembly in an open position, according to the present disclosure; and

FIG. 4B illustrates a perspective view of the assembled air filter assembly of FIG. 4A in a closed position, according to the present disclosure.

### DETAILED DESCRIPTION

Conventional air filters are unitary, disposable structures comprising an air filter media joined by adhesive to a disposable cardboard frame. The air filter media, which may comprise material such as nonwoven polyester, polyurethane foam, felt, laminate, paper, or natural fiber, is typically rolled out, cut into smaller sheets, and glued to the carboard frame. The cardboard frame is typically rigid, inflexible, and bulky, so bonding the air filter media to the cardboard frame ensures that the filter assembly will hold up against the force and/or pressure of air flow within an HVAC system.

In conventional air filter assemblies, when the air filter media becomes clogged with dirt and particles, the entire assembly must be discarded and replaced even though the cardboard frame remains in usable condition. This results in an unnecessary waste of resources. In addition, because conventional air filters are unitary assemblies having a bulky and rigid frame, they occupy a large amount of space when shipped in transport vehicles or stored on retailers' shelves, resulting in excessive shipping and storage costs.

Implementations of the present disclosure generally provide an improved air filter assembly comprising a long-lasting, reusable frame and a separate, replaceable air filter media. The components and features of the air filter assembly will be more fully described hereafter.

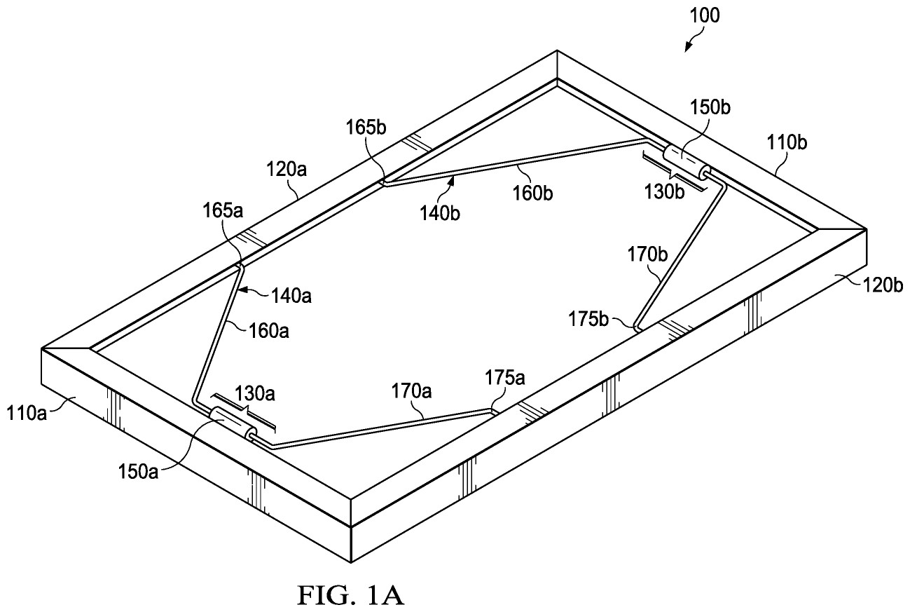

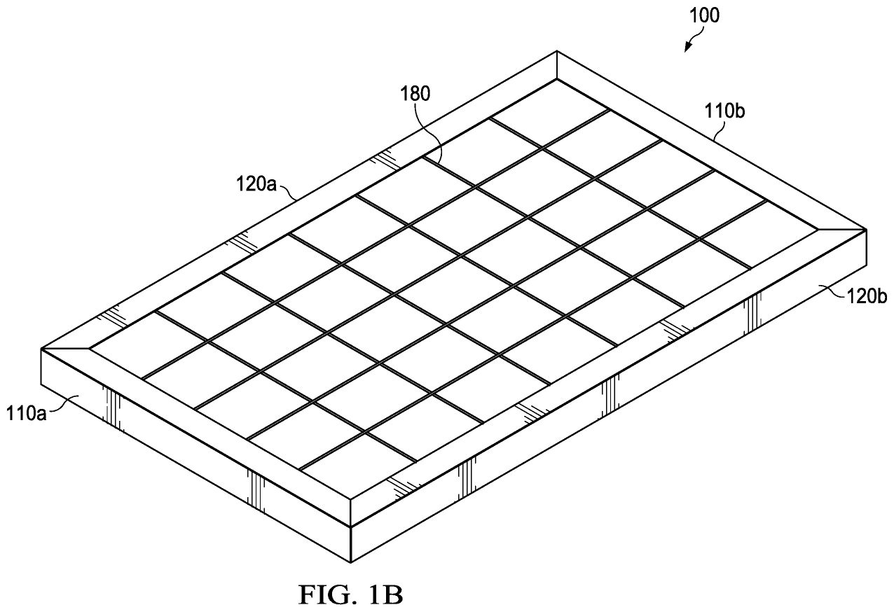

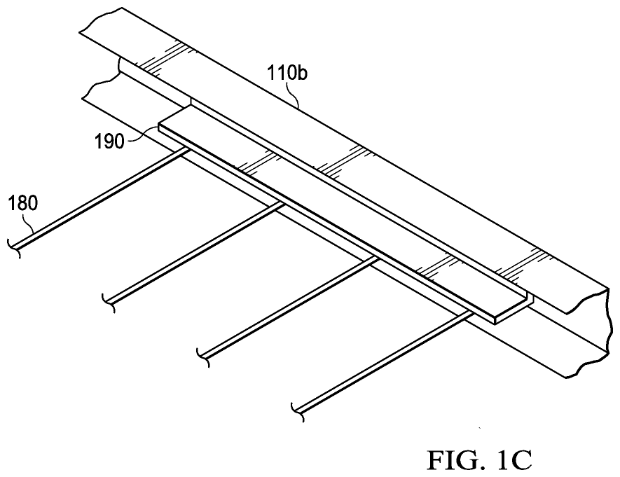

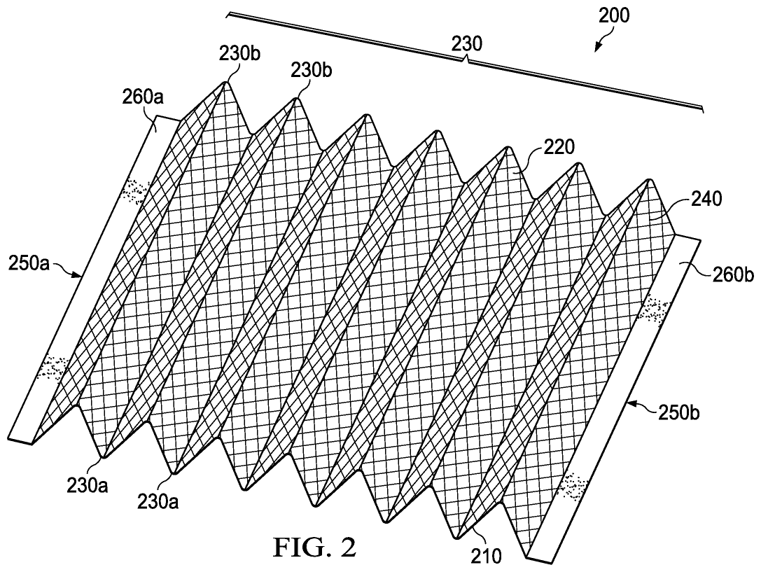

Reference is made to FIGS. 1A and 1B, wherein is shown an upstream side and a downstream side, respectively, of air filter frame 100. Frame 100 may be configured to releasably retain an air filter media (shown as element 200 in FIG. 2). Frame 100 may comprise four walls: a first side wall 110a, a second side wall 110b, a first end wall 120a, and a second end wall 120b. Each of the first and second side walls 110a, 110b and the first and second end walls 120a, 120b of the frame 100 may comprise a C-shaped configuration, which helps retain the air filter media 200 within the frame 100. In an implementation, frame 100 may be formed of metal. However, frame 100 may also be formed of other rigid and lasting materials such as plastics, woods, aluminums, and the like. In an implementation, the frame does not require regular replacement, and may be used for extended periods of time.

With reference to FIG. 1A, the frame 100 may further comprise on its upstream side at least one closure assembly 130a, 130b for securing the air filter media 200 within the frame 100. A first closure assembly 130a may comprise a spring-loaded fastener 140a pivotably coupled to the first side wall 110a via coupler 150a. As shown in FIG. 1A, frame 100 may further comprise a second closure assembly 130b having a second spring-loaded fastener 140b pivotably coupled to the second side wall 110b via coupler 150b. In an implementation, couplers 150a, 150b may each comprise a conduit though which the spring-loaded fasteners 140a, 140b may be inserted, respectively. In other implementations, couplers 150a, 150b may comprise a hinge, a shaft, or any other coupling mechanism known in the art.

With continued reference to FIG. 1A, spring-loaded fastener 140a may comprise two legs 160a, 170a which extend through the coupler 150a, with the first leg 160a extending to the first end wall 120a and the second leg 170a extending to the second end wall 120b. The ends of the first and second legs 160a, 170a may each comprise fastening ends 165a, 175a, respectively. Fastening ends 165a, 175a may be padded, and may comprise padding formed of plastic, foam, or other protective material. In operation, the first and second legs 160a, 170a of the spring-loaded fastener 140a may each be compressed towards one another while the fastening ends 165a, 175a are positioned to fit within the C-shaped walls of the first and second end walls 120a, 120b of the frame 100. Once positioned, the legs 160a, 170a may be released (i.e., expanded to their original position) such that the fastening ends 165a, 175a engage the C-shaped walls of the first and second end walls 120a, 120b to thereby secure the first and legs 160a, 170a within the frame 100.

The second spring loaded fastener 140b may similarly comprise first and second legs 160b, 170b which extend through the coupler 150b, with the first leg 160b extending to the first end wall 120a and the second leg 170b extending to the second end wall 120b. The ends of the first and second legs 160b, 170b may each comprise fastening ends 165b, 175b, respectively. Fastening ends 165b, 175b may be padded, and may comprise padding formed of plastic, foam, or other protective material. In operation, legs 160b, 170b be compressed towards one another, allowing the fastening ends 165b, 175b to be positioned to fit within the first and second end walls 120a, 120b, respectively. Then the legs 160b, 170b may be released—and the fastening ends 165b, 175b thereby secured—within the first and second end walls 120a, 120b of the frame 100.

Although FIG. 1A depicts two closure assemblies 130a, 130b, it is to be understood that the present disclosure is not to be so limited and may contemplate any number of closure assemblies to secure the filter media 200 within the frame 100. Further, although the two fasteners 140a, 140b of FIG. 1A are described as comprising spring-loaded closure assemblies 130a, 130b, it is to be understood that the present disclosure is not to be so limited. The closure assemblies 130a, 130b may alternatively comprise any form or mechanism for fastening and/or securing known or conceived in the art.

With reference now to FIGS. 1B and 1C, frame 100 may further comprise an efficiency grid 180 on its downstream side. The efficiency grid 180 may provide structural support for the air filter media while minimizing impediments to air flow through the air filter assembly during operation of the air filter assembly. In an implementation, efficiency grid 180 may comprise a metal grid formed of a series of overlapping vertical and horizontal wires. In an implementation, the space between the vertical wires of the grid 180 (the wires extending from the first end wall 120a to the second end wall 120b) may be 2 inches, and the space between the horizontal wires of the grid 180 (the wires extending from the first side wall 110a to the second side wall 110b) may be 4 inches. In an implementation, the efficiency grid 180 may comprise a 14-gauge galvanized welded wire mesh. Although the efficiency grid 180 of FIGS. 1B and 1C is described as formed of overlapping metal wires and/or welded wire mesh, it is to be understood that the present disclosure is not to be so limited and the efficiency grid 180 may be formed of any material (including plastic, wood, aluminum, and the like), and its constituent parts may be arranged in any manner and with any degree of spacing.

As shown in FIG. 1C, the efficiency grid 180 may be inserted into and retained within the frame 100 via a partition wall 190 that may be joined or formed within each of the first and second side walls 110a, 110b of the frame 100. In an implementation, a partition wall 190 may further, or alternatively, be joined or formed within each of the first and second end walls 120a, 120b. In an implementation, the efficiency grid 180 may be separable from the frame 100.

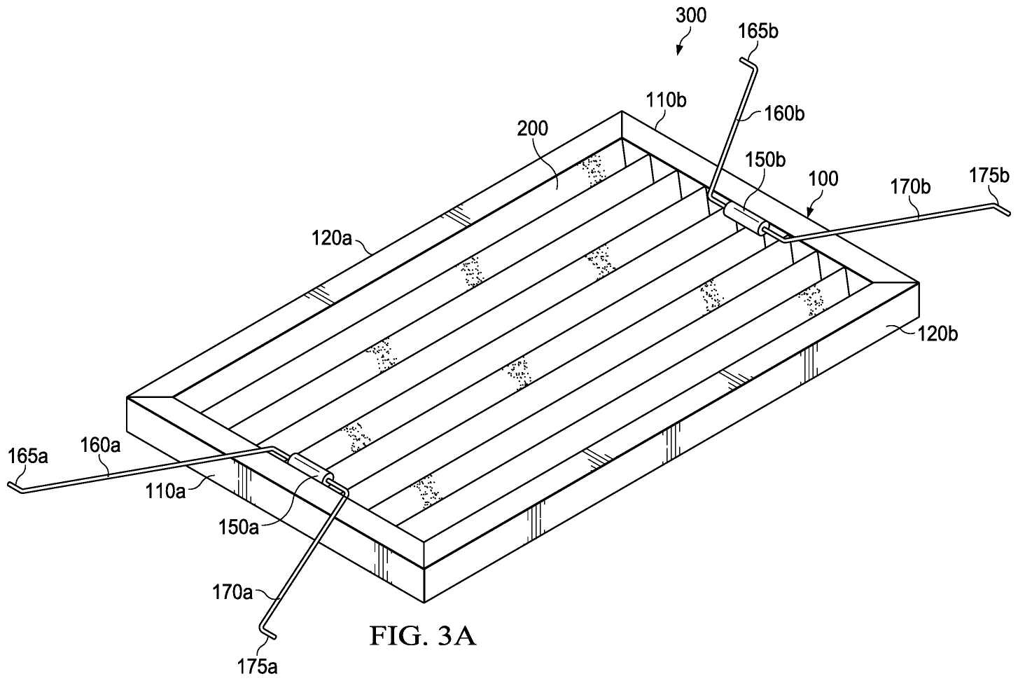

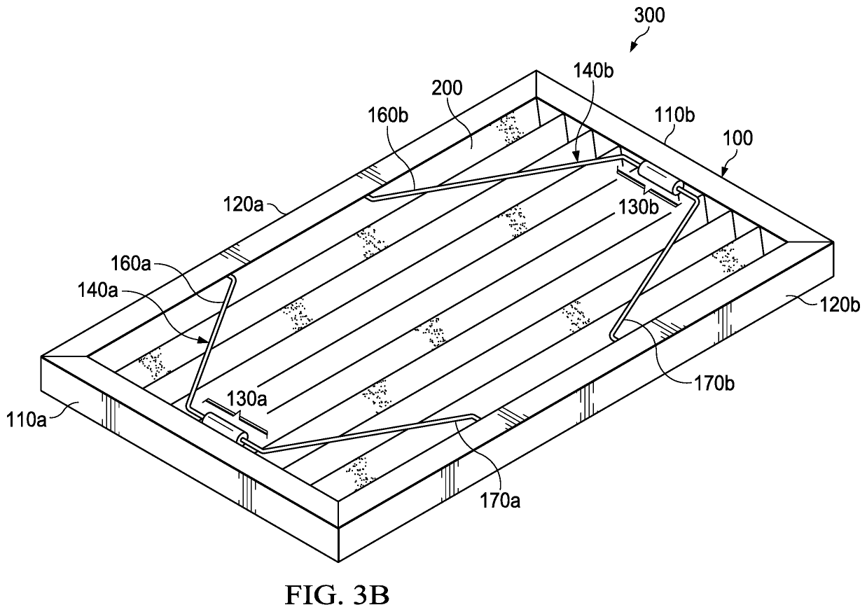

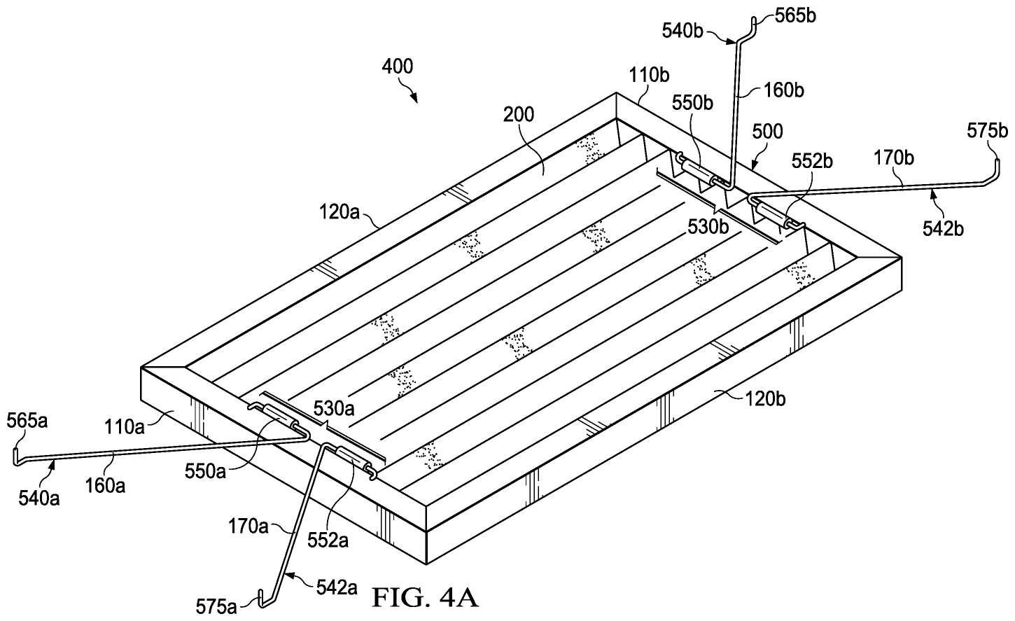

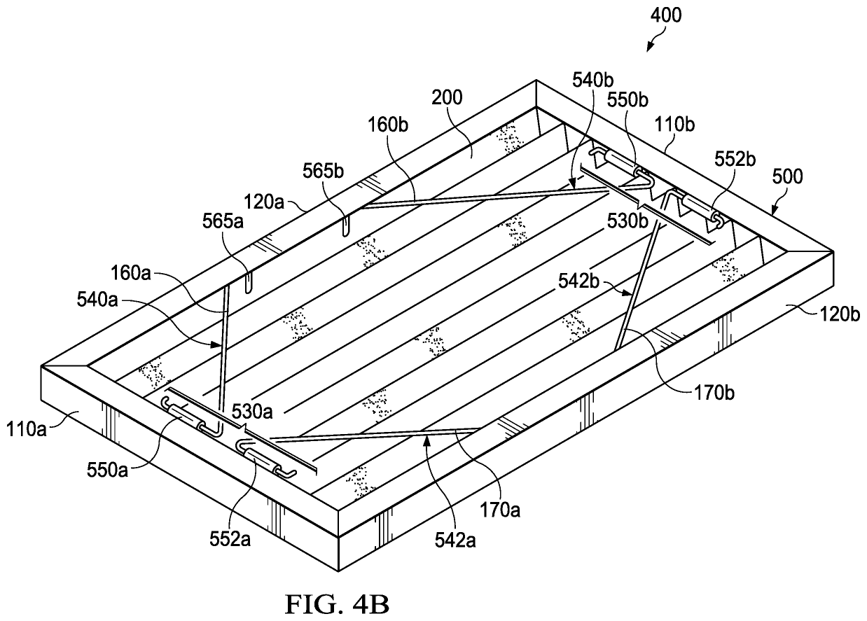

Reference is now made to FIG. 2, wherein is shown an air filter media 200 configured to be removeably installed into a frame 100 of an air filter assembly 300, 400 (shown as element 300 in FIGS. 3A and 3B, and shown as element 400 in FIGS. 4A and 4B). Air filter media 200 may be constructed of various materials such as nonwoven fibrous media, porous foams, papers, fiberglass, and the like. Air filter media 200 may comprise an upstream side 210 and a downstream side 220. The upstream side 210 of the air filter media 200 corresponds to the lower side of the air filter media, as shown in FIG. 2. The upstream side 210 is the side through which moving air enters the air filter media 200 when the air filter assembly 300, 400 is installed. The downstream side 220 of the air filter media 200 corresponds to the upper side of the air filter media 200, as shown in FIG. 2. The downstream side 220 is the side through which moving air exits the air filter media 200 when the air filter assembly 300, 400 is installed.

According to an implementation, air filter media 200 may be pleated (depicted in FIG. 2 by pleats 230 having upstream pleat folds 230a and downstream pleat folds 230b). The term “pleated” refers to a folded configuration comprising rows of generally parallel, similarly-sized, oppositely-oriented folds. Pleated air filter media 200 may be transitioned between an extended (stretched out) state and a collapsed (folded or compressed) state. The pleated air filter media 200 may come in a variety of heights, as measured when the pleated air filter media 200 is installed within an air filter assembly 300, 400. In various implementations, the pleated air filter media 200 may come in heights ranging from about 0.5 inches to about 5 inches. In one implementation, the pleated air filter media 200 may come in a height of about 1 inch. In another implementation, the pleated air filter media 200 may come in a height of about 4 inches.

An air filter media having a pleated construction may offer a number of advantages. First, a pleated construction increases the surface area of the air filter media 200 within the air filter assembly 300, thereby allowing the air filter media 200 to trap more dirt, dust and other contaminants that are in the air. A pleated air filter also distributes air more evenly than a non-pleated filter, increasing the efficiency of the HVAC system in which the filter is installed.

Additionally, air filter media 200 may be replaceable. In other words, when after a period of use, the air filter media 200 becomes clogged with dust and particles, the used air filter media may be removed from within the frame 100 and replaced with a new air filter media. In accordance with the present disclosure, a replaceable pleated air filter media 200 may have additional advantages. First, because a replaceable pleated air filter media 200 is separable from the frame 100 in which it is installed, air filter media 200 may be transported, shipped, and stored separately from the frame 100. As a result, a plurality of replaceable air filter media may be nested, one atop another, such that corresponding upstream and downstream pleat folds may be arranged in a stacked formation, thereby increasing the number of air filter media that can be shipped, transported, and/or stored at any one time by retailers or end users. In another implementation, replaceable pleated air filter media 200 may be shipped, transported, and/or stored in a collapsed (folded) state, minimizing the space required for a single air filter media and thereby increasing the total number of filter media that may be arranged within a given storage space.

With continued reference to FIG. 2, according to an implementation, air filter media 200 may further comprise a wire mesh or netting 240. Wire netting 240 may comprise a lattice of wire filaments adhesively bonded to the air filter media 200. Wire netting 240 may enhance the pleatability of the air filter media 200 and help maintain its pleated construction, both during operation of the air filter assembly and during shipping and/or storage of the air filter media 200.

With continued reference to FIG. 2, air filter media 200 may further comprise a first side end 250a and a second side end 250b. First and second side ends 250a, 250b may comprise the left and right ends of the air filter media 200, respectively, and may run parallel to the direction of the pleats 230. Because the sharp ends of wire filaments that form the wire netting 240 may begin and/or end on the first and second side ends 250a, 250b of the air filter media 200, the first and second side ends 250a, 250b may be difficult to manipulate by a user. In an implementation, a graspable end member 260a, 260b may be adhesively adjoined to each of the first and second side ends 250a, 250b, respectively, of the air filter media 200. Graspable end members 260a, 260b may be substantially identical to one another and may serve as “handles” that the user may use to grasp and manipulate the air filter media 200 into and out of the frame 100 (i.e., to insert the air filter media 200 into and remove the air filter media 200 out of the frame 100). Graspable end members 260a, 260b may comprise paper, paperboard, plastic, rubber, metals, or any other rigid or semi-rigid material. Although FIG. 2 depicts graspable end members 260a, 260b as encompassing and covering the full length of first and second side ends 250a, 250b of the air filter media 200, the present disclosure is not intended to be so limiting. Graspable end members 260a, 260b may extend any length along the first and second side ends 250a. 250b, and may alternatively cover only a portion of the first and second side ends 250a, 250b of the air filter media 200.

Reference is now made to FIGS. 3A and 3B, wherein is shown an assembled air filter assembly 300 in an open and closed configuration, respectively, according to the present disclosure. Air filter assembly 300 may comprise the replaceable air filter media 200 of FIG. 2 which may be releasably retained within the frame 100 of FIGS. 1A and 1B. In various implementations, the replaceable air filter media 200 used within frame 100 may range in height from about 0.5 inches to about 2 inches, and in one implementation, the replaceable air filter media 200 used within frame 100 may have a nominal height of about 1 inch.

As shown in FIG. 3A, in operation, when spring-loaded fasteners 140a, 140b of the frame 100 are pivoted to their open positions, a user may insert the replaceable air filter media 200 into the frame 100 by manipulating graspable end members 260a, 260b (not shown) of the air filter media 200 and placing the first side end 250a of the air filter media 200 into the first end wall 120a of the frame 100 and the second side end 250b of the air filter media 200 into the second end wall 120b of the frame 100. Likewise, the user may tuck the top and bottom edges of the air filter media 200 into the first side wall 110a and the second side wall 110b, respectively, of the frame 100.

Once the air filter media 200 has been inserted into the frame 100, the spring-loaded fasteners 140a, 140b may be pivoted to their closed positions, as shown in FIG. 3B. As described above, the first and second legs 160a, 170a of the spring-loaded fastener 140a may be compressed together and positioned such that fastening ends 165a, 175a will be captured within the C-shaped walls of the first and second end walls 120a, 120b of the frame 100 when the first and second legs 160a, 170a are released. Likewise, the first and second legs 160b, 170b of the second spring-loaded fastener 140b may be compressed together and positioned such that fastening ends 165b, 175b will be captured within the first and second end walls 120a, 120b of the frame 100 when the first and second legs 160b, 170b are released. Once appropriately positioned, the legs 160a, 170a (and 160b, 170b) may be released to secure the fastening ends 165a, 175a (and 165b, 175b) of the spring-loaded fastener 140a, 140b within the frame 100.

As described herein, the air filter assembly 300 of the present disclosure comprises a long-lasting, reusable frame 100 and a replaceable air filter media 200. In an implementation, a user may purchase the air filter assembly 300 for use with an HVAC system. After a period of use, the user may replace just the clogged air filter media 200 while continuing to use the frame 100. Over time, the air filter assembly 300 may provide savings in costs, as well as in resources.

Reference is now made to FIGS. 4A and 4B, wherein is shown another implementation of an assembled air filter assembly 400 in an open and closed configuration, respectively, according to the present disclosure. The frame 500 of air filter assembly 400 is similar in some respects to frame 100 of FIG. 1, and like reference numerals indicate like features. However, in various implementations, the frame 500 of FIGS. 4A and 4B may be configured to hold replaceable air filter media 200 that range in height from about 2 inches to about 5 inches, and in one implementation, the replaceable air filter media 200 used within frame 500 may have a nominal height of about 4 inches.

The frame 500 of air filter assembly 400 may include on its upstream side at least one modified closure assembly 530a, 530b for securing such implementations of air filter media 200 within the frame 500. A first modified closure assembly 530a may comprise a first set of spring-loaded fasteners 540a, 542a pivotably coupled to the first side wall 110a via a first set of couplers 550a, 552a, respectively. Frame 500 may further comprise a second closure assembly 530b having a second set of spring-loaded fasteners 540b, 542b pivotably coupled to the second side wall 110b via a second set of couplers 550b, 552b, respectively. In an implementation, couplers 550a, 552a, 550b, 552b may each comprise a conduit though which the spring-loaded fasteners 540a, 542a, 540b, 542b may be inserted, respectively. In other implementations, couplers 550a, 552a, 550b, 552b may comprise a hinge, a shaft, or any other coupling mechanism known in the art.

The first set of spring-loaded fasteners 540a, 542a may each comprise a leg 160a, 170a, respectively, which extend through the first set of couplers 550a, 552a. The first leg 160a may extend to the first end wall 120a and the second leg 170a may extend to the second end wall 120b. The ends of the first and second legs 160a, 170a may each comprise fastening ends 565a, 575a, respectively. Fastening ends 565a, 575a may extend generally perpendicular to the first and second legs 160a, 170a such that the fastening ends 565a, 575a extend downwardly toward the downstream side of the frame 500 to engage the interior bottom of the C-shaped first end wall 120a and second end wall 120b, respectively, as shown in FIG. 4B. Fastening ends 565a, 575a may comprise padding formed of plastic, foam, or other protective material.

In operation, the first and second legs 160a, 170a of the first set of spring-loaded fasteners 540a, 542a may each be compressed towards one another while the fastening ends 565a, 575a are positioned to fit within the C-shaped walls of the first and second end walls 120a, 120b of the frame 500. Once positioned, the legs 160a, 170a may be released (i.e., expanded to their original position) such that the fastening ends 565a, 575a engage the bottom of the C-shaped walls of the first and second end walls 120a, 120b to thereby secure the first and second legs 160a, 170a within the frame 500.

The second set of spring-loaded fasteners 540b, 542b may each similarly comprise a leg 160b, 170b, respectively, which extends through the second set of couplers 550b, 552b. The first leg 160b may extend to the first end wall 120a and the second leg 170b may extend to the second end wall 120b. The ends of the first and second legs 160b, 170b may each comprise fastening ends 565b, 575b, respectively. Fastening ends 565b, 575b may extend generally perpendicular to the first and second legs 160b, 170b such that the fastening ends 565b, 575b extend downwardly toward the downstream side of the frame 500 to engage the interior bottom of the C-shaped first end wall 120a and second end wall 120b, respectively, as shown in FIG. 4B. Fastening ends 565b, 575b may comprise padding formed of plastic, foam, or other protective material.

In operation, the first and second legs 160b, 170b of the second set of spring-loaded fasteners 540b, 542b may each be compressed towards one another while the fastening ends 565b, 575b are positioned to fit within the C-shaped walls of the first and second end walls 120a, 120b of the frame 500. Once positioned, the legs 160b, 170b may be released (i.e., expanded to their original position) such that the fastening ends 565b, 575b engage the bottom of the C-shaped walls of the first and second end walls 120a, 120b to thereby secure the first and second legs 160b, 170b within the frame 500.

Although FIGS. 4A and 4B depict two closure assemblies 530a, 530b, it is to be understood that the present disclosure is not to be so limited and may contemplate any number of closure assemblies to secure the filter media 200 within the frame 500. Further, although the fasteners 540a, 542a, 540b, 542b are described as comprising spring-loaded closure assemblies 530a, 530b, it is to be understood that the present disclosure is not to be so limited. The closure assemblies 530a, 530b may alternatively comprise any form or mechanism for fastening and/or securing known or conceived in the art.

Referring again to FIGS. 4A and 4B, wherein is shown an implementation of an assembled air filter assembly 400 in an open and closed configuration, respectively, according to the present disclosure. Air filter assembly 400 may comprise the replaceable air filter media 200 of FIG. 2 which may be releasably retained within the frame 500. As shown in FIG. 4A, when spring-loaded fasteners 540a, 542a, 540b, 542b of the frame 500 are pivoted to their open positions, a user may insert the replaceable air filter media 200 into the frame 500 by manipulating graspable end members 260a, 260b (not shown) of the air filter media 200 and placing the first side end 250a of the air filter media 200 into the first end wall 120a of the frame 500 and the second side end 250b of the air filter media 200 into the second end wall 120b of the frame 500. Likewise, the user may tuck the top and bottom edges of the air filter media 200 into the first side wall 110a and the second side wall 110b, respectively, of the frame 500.

Once the air filter media 200 has been inserted into the frame 500, the spring-loaded fasteners 540a, 542a, 540b, 542b may be pivoted to their closed positions, as shown in FIG. 4B. As described above, the first and second legs 160a, 170a of the first set of spring-loaded fasteners 540a, 542a may be compressed together and positioned such that fastening ends 565a, 575a will be captured within the C-shaped walls of the first and second end walls 120a, 120b of the frame 500 when the first and second legs 160a, 170a are released. Likewise, the first and second legs 160b, 170b of the second set of spring-loaded fasteners 540b, 542b may be compressed together and positioned such that fastening ends 565b, 575b will be captured within the first and second end walls 120a, 120b of the frame 500 when the first and second legs 160b, 170b are released. Once appropriately positioned, the legs 160a, 170a (and 160b, 170b) may be released to secure the fastening ends 565a, 575a (and 565b, 575b) of the spring-loaded fastener 540a, 542a, 540b, 542b within the frame 500.

As described herein, the air filter assembly 400 of the present disclosure comprises a long-lasting, reusable frame 500 and a replaceable air filter media 200. In an implementation, a user may purchase the air filter assembly 400 for use with an HVAC system. After a period of use, the user may replace just the clogged air filter media 200 while continuing to use the frame 500. Over time, the air filter assembly 400 may provide savings in costs, as well as in resources.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” and “joining” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An air filter assembly comprising:
a pleated air filter media having an upstream surface, a downstream surface, a first side end, and a second side end;
a wire netting adjoined to the downstream surface of the air filter media;
a graspable end member adjoined to each of the first and second side ends of the air filter media;
a frame configured to releasably retain the air filter media, the frame having first and second ends walls and first and second side walls;
a closure assembly for securing the air filter media within the frame, the closure assembly comprising a spring-loaded fastener pivotably coupled to at least one of the first and second side walls and configured to fasten to at least one of the first and second end walls; and
an efficiency grid retained within the frame.

2. The air filter assembly of claim 1, wherein the first and second side ends of the air filter media run parallel to the pleats of the air filter media.

3. The air filter assembly of claim 1, wherein the first and second end walls and the first and second side walls of the frame are c-shaped.

4. The air filter assembly of claim 1, wherein the frame further comprises:
a partition wall disposed within each of the first and second side walls for retaining the efficiency grid.

5. The air filter assembly of claim 1, wherein the efficiency grid comprises:
a plurality of vertical wires extending between the first and second end walls; and
a plurality of horizontal wires extending between the first and second side walls.

6. The air filter assembly of claim 5, wherein:
the plurality of vertical wires are spaced apart by approximately 2 inches; and
the plurality of horizontal wires are spaced apart by approximately 4 inches.

7. The air filter assembly of claim 1, wherein the efficiency grid provides structural support for the air filter media while minimizing impediments to air flow through the air filter assembly during operation of the air filter assembly.

8. The air filter assembly of claim 1, wherein the spring-loaded fastener comprises:
a first leg configured to fasten to the first end wall; and
a second leg configured to fasten to the second end wall.

9. The air filter assembly of claim 8, wherein the first and second legs comprise: fastening ends.

10. The air filter assembly of claim 1, wherein the graspable end member allows a user to manipulate the air filter media into and out of the frame.

11. The air filter assembly of claim 1, wherein the frame is metal.

12. An air filter assembly comprising:
a replaceable air filter media;
a frame configured to releasably retain the air filter media;
an efficiency grid disposed within the frame for supporting the air filter media during operation of the air filter assembly; and
a closure assembly for securing the air filter media within the frame.

13. The air filter assembly of claim 12, wherein the replaceable air filter media is pleated.

14. The air filter assembly of claim 12, wherein the replaceable air filter media comprises:
an end member adjoined to each of first and second ends of the air filter media for grasping the air filter media.

15. The air filter assembly of claim 12, wherein the efficiency grid comprises:
14-gauge galvanized welded wire mesh.

16. The air filter assembly of claim 12, wherein the closure assembly comprises:
a spring-loaded fastener coupled to a first side of the frame and configured to fasten to a second side of the frame.

17. An air filter assembly comprising:
a replaceable air filter media;
a frame configured to releasably retain the air filter media;
a closure assembly for securing the air filter media within the frame, wherein the closure assembly comprises at least one spring-loaded fastener coupled to a first side of the frame and configured to fasten to a second side of the frame; and
an efficiency grid configured to be retained within the frame.

18. The air filter assembly of claim 17, wherein the frame comprises:
four c-shaped sides.

19. The air filter assembly of claim 18, further comprising:
a partition wall disposed within at least two of the c-shaped sides of the frame for retaining the efficiency grid.

20. The air filter assembly of claim 17, wherein the efficiency grid and the air filter media are retained with the frame such that the efficiency grid is disposed adjacent to a downstream surface of the air filter media.
